(19) United States
(12) Patent Application Publication
(10) Pub. No.: US 2025/0219126 A1
(43) Pub. Date: Jul. 3, 2025

(54) METHOD FOR MANUFACTURING A POWER STORAGE DEVICE

(71) Applicant: Prime Planet Energy & Solutions, Inc., Tokyo (JP)

(72) Inventor: Katsuya SHIKATA, Nisshin-shi (JP)

(21) Appl. No.: 18/963,527

(22) Filed: Nov. 28, 2024

(30) Foreign Application Priority Data
Dec. 28, 2023 (JP) 2023-223222

(51) Int. Cl. H01M 10/04; G01B 11/16; H01M 10/48; H01M 50/169

(52) U.S. Cl. CPC H01M 10/0481; G01B 11/16; H01M 10/486; H01M 50/169

(57) ABSTRACT

A method for manufacturing a power storage device includes accumulating correlation graph data between a warpage displacement amount of a sealing member with respect to a support point in a front-back direction of the accuracy requiring surface and a corrective deformation amount of the accuracy requiring surface corrected by deformation in an opposite direction to the front-back direction until a position at which the accuracy requiring surface can restore by its own elastic force to a normal position, measuring a warpage displacement amount, and determining whether or not the warpage displacement amount satisfies a reference value. Correcting the sealing member includes applying a load to the accuracy requiring surface determined to fail to satisfy the reference value until a position corresponding to a corrective deformation amount determined when the measured warpage displacement amount coincides with the warpage displacement amount in the correlation graph data, and then removing the load.

### CROSS-REFERENCE TO RELATED APPLICATIONS

This application is based upon and claims the benefit of priority to Japanese Patent Application No. 2023-223222 filed on Dec. 28, 2023, the entire contents of which are incorporated herein by reference.

### BACKGROUND

### Technical Field

The disclosure relates to a method for manufacturing a power storage device.

### Related Art

Conventionally, in a power storage device provided with an electrode body in a case, when bonding an end part of the electrode body (a part not coated with active material) and a current collector terminal, for example, external force may be applied to the current collector terminal, causing the current collector terminal to be deformed. Due to such deformation of the current collector terminal, and so on, a sealing member of the case with positive and negative current collector terminals bonded to end parts of the electrode body at both ends in the long-side direction may be displaced and warped in the front-back direction, asymmetrically between both ends, i.e., left and right sides of the sealing member.

In this regard, for example, Japanese unexamined patent application publications No. 2009-026705 (JP 2009-026705A) and No. 2019-125486 (JP 2019-125486A) disclose the arts for reducing the deformation of current collector terminals against external force by enhancing the rigidity of the current collector terminals.

### SUMMARY

### Technical Problems

However, even if the rigidity of the current collector terminal is enhanced, the rigidity of the sealing member is generally lower than that of the current collector terminal and thus the external force acting on the current collector terminal is substantially directly transmitted to the sealing member with the current collector terminal bonded thereto. This causes a problem that warpage of the sealing member could not be sufficiently suppressed. In addition, the amount of warpage displacement of the sealing member varies in magnitude for each power storage device to be manufactured. Normally, the front surface, i.e., outer surface, of the sealing member has an accuracy requiring surface that requires a better accuracy of surface positioning (surface position accuracy) than other areas, for example, like a sensor contact surface formed to be contactable with a temperature sensor for monitoring the temperature of the power storage device. The surface position accuracy of this accuracy requiring surface needs to be within a required reference value.

The present disclosure has been made to address the above problems and has a purpose to provide a method for manufacturing a power storage device with high reliability, in which even when a warpage displacement amount of a sealing member varies for each power storage device to be manufactured and the warpage displacement amount is asymmetric between right and left sides of each sealing member, a corrective deformation amount can be changed according to the warpage displacement amount, allowing an accuracy requiring surface of the sealing member to be corrected so that the warpage displacement amount is within a reference value.

### Means of Solving the Problems

(1) To solve the above-mentioned problems, one aspect of the disclosure provides a method for manufacturing a power storage device, the method including correcting a sealing member that sealingly closes an opening portion of a case containing an electrode body, prior to welding the sealing member to the opening portion of the case, wherein the sealing member has a front surface including an accuracy requiring surface that requires a required surface position accuracy, the method comprises: creating database by accumulating in advance correlation graph data between a warpage displacement amount of the accuracy requiring surface displaced in a front-back direction relative to a support point of the sealing member inserted in the opening portion of the case and a corrective deformation amount by which the accuracy requiring surface displaced by the warpage displacement amount is subjected to corrective deformation toward an opposite side in the front-back direction to a displacement direction of the accuracy requiring surface relative to the support point until the accuracy requiring surface reaches a position from which the accuracy requiring surface can be restored by its own elastic force to a normal position at which the warpage displacement amount is zero; measuring a warpage displacement amount of the accuracy requiring surface after the sealing member is inserted in the opening portion; determining whether or not the warpage displacement amount of the accuracy requiring surface measured in measuring the warpage displacement amount satisfies a required reference value, and when it is determined, in determining the warpage displacement amount, that the warpage displacement amount does not satisfy the required reference value, correcting the sealing member is performed by applying a load to the accuracy requiring surface until a position corresponding to the corrective deformation amount determined when the warpage displacement amount measured in measuring the warpage displacement amount coincides with the warpage displacement amount in the correlation graph data, and then removing the load.

(2) In the method for manufacturing a power storage device, described in (1), the accuracy requiring surface may be a sensor contact surface formed to be contactable with a temperature sensor for monitoring a temperature of the power storage device.

(3) The method for manufacturing a power storage device, described in (1) or (2) may be configured such that the accuracy requiring surface in the front surface of the sealing member includes a plurality of accuracy requiring surfaces, measuring the warpage displacement amount includes measuring the warpage displacement amount of each of the accuracy requiring surfaces, when it is determined, in determining the warpage displacement amount, that the warpage displacement amount of at least one of the accuracy requiring surfaces does not satisfy the required reference value, correcting the sealing member is performed by applying the load to each of the accuracy requiring surfaces until the position corresponding to an average value of the corrective deformation amounts each determined when each of the warpage displacement amounts measured in measuring the warpage displacement amount coincides with the warpage displacement amount in the correlation graph data, and then removing the load.

### BRIEF DESCRIPTION OF THE DRAWINGS

FIG. 1 is a schematic plan view of a power storage device manufactured by a method for manufacturing a power storage device according to one aspect of an embodiment;

FIG. 2 is a schematic cross-sectional view taken along a line A-A in FIG. 1, showing that a temperature sensor is disposed in contact with a sensor contact surface of a sealing member;

FIG. 3 is a schematic perspective view showing that an electrode body shown in FIG. 2 is partially wound back;

FIG. 4 is a cross-sectional view taken along a line B-B in FIG. 2;

FIG. 5 is a flowchart showing the method for manufacturing the power storage device shown in FIG. 1;

FIG. 6 is one example of correlation graph data accumulated in a database creating step in the flowchart in FIG. 5;

FIG. 7 is a schematic cross-sectional view showing a method for measuring a warpage displacement amount of an accuracy requiring surface in the database creating step and a surface displacement measuring step in the flowchart in FIG. 5;

FIG. 8 is a schematic cross-sectional view of a correcting device for correcting the warpage displacement amount of the accuracy requiring surface in a correcting step in the flowchart in FIG. 5;

FIG. 9 is a schematic cross-sectional view of the correcting device shown in FIG. 8, in which a load is applied to a sealing member so that the accuracy requiring surface is deformed with a corrective deformation amount; and

FIG. 10 is a schematic cross-sectional view of the correcting device shown in FIG. 8, in which the load applied to deform the accuracy requiring surface with the corrective deformation amount is removed.

### DETAILED DESCRIPTION OF THE EXEMPLARY EMBODIMENTS

### Description of Whole Power Storage Device

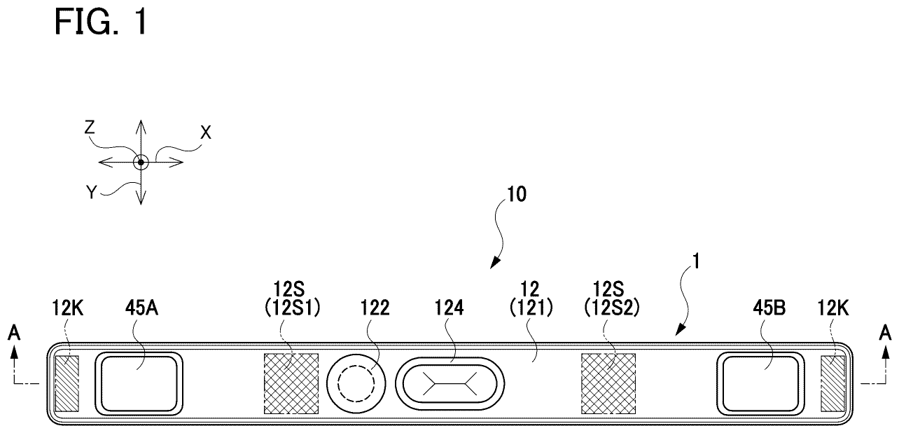

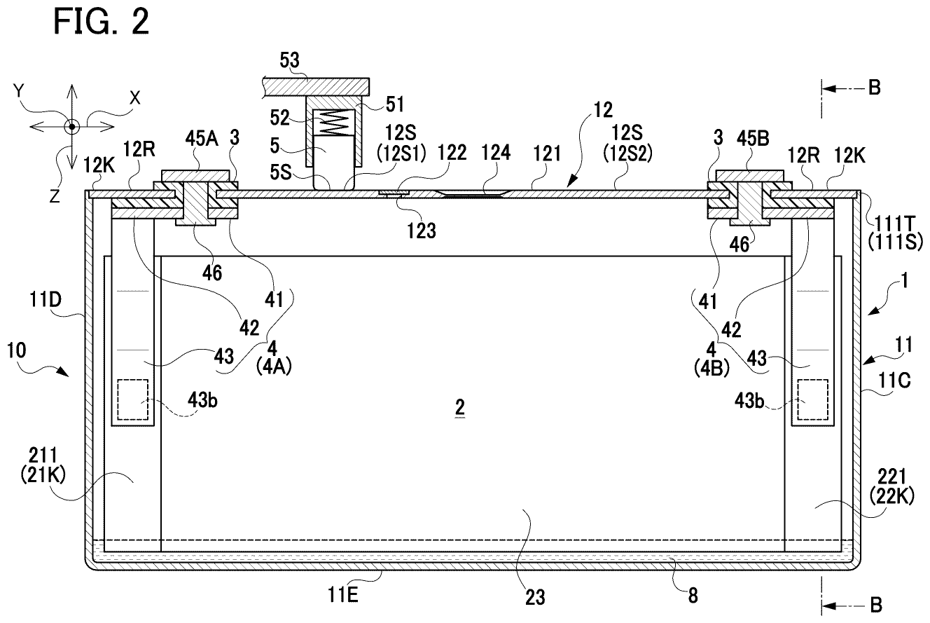

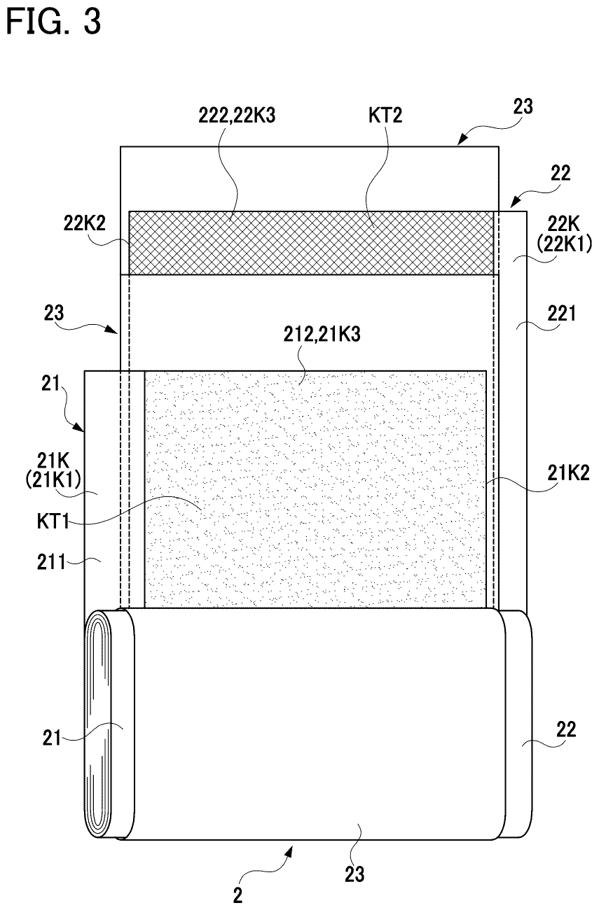

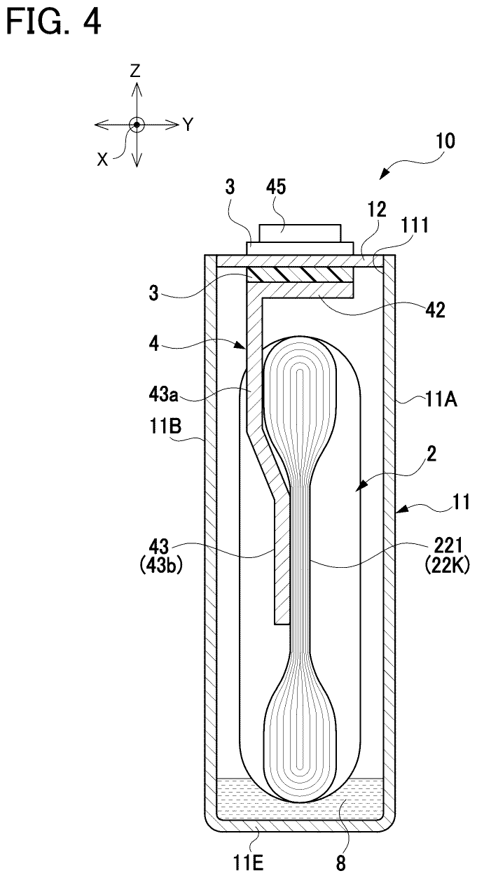

The following description will be given to the overall structure of a power storage device manufactured by a power storage device manufacturing method according to one aspect of an embodiment of the disclosure, referring to the accompanying drawings. FIG. 1 is a schematic plan view of the power storage device manufactured by the power storage device manufacturing method according to one aspect of the embodiment. FIG. 2 is a cross-sectional view taken along a line A-A in FIG. 1, showing that a temperature sensor is disposed in contact with a sensor contact surface of a sealing member. FIG. 3 is a schematic perspective view showing that an electrode body shown in FIG. 2 is partially wound back. FIG. 4 is a cross-sectional view taken along a line B-B in FIG. 2. In each figure, a direction X indicates a long-side direction of the sealing member, a direction Y indicates a short-side direction of the sealing member, and a direction Z indicates a front-back direction (i.e., a thickness direction) of the sealing member.

A power storage device 10 manufactured by the power storage device manufacturing method in the embodiment includes a case 1, an electrode body 2, and current collector terminals 4, as shown in FIG. 1 to FIG. 4. Herein, the case 1 has a bottomed rectangular prismatic case body 11 with a rectangular opening portion 111, and a long, flat plate-like sealing member 12 that sealingly closes the opening portion 111, as shown in FIG. 1 and FIG. 2. The sealing member 12 is provided with a liquid inlet 123 for pouring of an electrolyte 8 into the case 1, a stopper 122 that sealingly covers the liquid inlet 123, and a safety valve 124 configured to break open when the internal pressure of the case 1 rises above a predetermined value. The case body 11 and the sealing member 12 are each made of aluminum. This sealing member 12 is specifically made of a material softer and more easily deformable than the current collector terminals 4 due to the need to improve the valve opening performance of the safety valve 124.

The opening portion 111 of the case body 11 includes a thin-walled portion 111T formed only in each inner wall of short side surfaces 11C, 11D. Therefore, each of end portions 12R on both sides in the long-side direction (the direction X) of the sealing member 12 inserted in the opening portion 111 is supported by a shoulder 111S formed at a lower end of each thin-walled portion 111T, and each end portion 12R corresponds to a support point 12K of the sealing member 12. The opening portion 111 of the case body 11 is configured such that no thin-walled portion is formed in each inner wall of long side surfaces 11A, 11B and thus is difficult to prevent the central part of the sealing member 12 from displacing (warpage deformation) in the front-back direction, i.e., the direction Z.

Further, the electrode body 2 is constituted of a positive electrode body 21 and a negative electrode body 22, stacked and wound in a flat shape with separators 23 interposed, and this electrode body 2 is housed in the case body 11 as shown in FIG. 2 to FIG. 4. The positive electrode body 21 includes an active-material uncoated part 211 where one end portion 21K1 of a metal foil 21K is not coated with an active material KT1 and an active-material coated part 212 where the metal foil 21K is coated with the active material KT1. Similarly, the negative electrode body 22 includes an active-material uncoated part 221 where one end portion 22K1 of a metal foil 22K is not coated with an active material KT2 and an active-material coated part 222 where the metal foil 22K is coated with the active material KT2. The active-material uncoated part 211 of the positive electrode body 21 and the active-material uncoated part 221 of the negative electrode body 22 are located opposite each other in the long-side direction (the direction X) of the sealing member 12. The active-material coated parts 212, 222 are respectively formed in the other end portions 21K2, 22K2 and intermediate portions 21K3, 22K3 of the metal foils 21K, 22K.

The power storage device 10 in this embodiment refers to all power storage devices that can generate electric energy to be extracted, and may include for example primary batteries, secondary batteries, electric double layer capacitors, and so on. For example, in a lithium ion secondary battery, the metal foil 21K of the positive electrode body 21 may be for example an aluminum foil, and carry thereon the active material KT1 made of e.g. lithium transition metal oxide (LiNi_{1/3}Co_{1/3}Mn_{1/3}O₂, LiNiO₂, etc.). Further, the metal foil 22K of the negative electrode body 22 may be for example a copper foil, and carry thereon the active material KT2 made of e.g. black carbon, hard carbon, soft carbon, etc. Each separator 23 may be a porous sheet, made of e.g. polypropylene, polyethylene, etc. The electrolyte 8 may be a well-known non-aqueous electrolyte.

The current collector terminals 4 include a current collector terminal 4A for positive electrode and a current collector terminal 4B for negative electrode. The positive current collector terminal 4A is made of e.g. aluminum and the negative current collector terminal 4B is made of e.g. copper. Commonly, the tension strength of the positive current collector terminal 4A made of aluminum is lower than that of the negative current collector terminal 4B made of copper, and the electric conductivity of the positive current collector terminal 4A is lower than that of the negative current collector terminal 4B. Accordingly, the thickness of the positive current collector terminal 4A is set thicker than that of the negative current collector terminal 4B to uniformize those current collector terminals 4A and 4B in strength and allowable current amount. The positive and negative current collector terminals 4 each have a base portion 41, a base adjoining portion 42, and a lead portion 43, which are formed in one piece.

The base portion 41 is connected to an external connection part 45 (45A, 45B) located on the front, i.e., outer, surface of the sealing member 12 with a swaged pin 46 or the like, for example. When the base portion 41, the external connection part 45, and the sealing member 12 are connected together with the swaged pin 46 or the like, the external force is applied to the sealing member 12, which may cause displacement of the central part of the sealing member 12 in the front-back direction (the direction Z). It is noted that an insulating member 3 also serving as a seal material is interposed between the swaged pin 46 and the sealing member 12 and between the external connection part 45 and the sealing member 12. The insulating member 3 may be made of for example polyphenylene sulfide (PPS). The external connection part 45 (45A, 45B) is connectable to a busbar (not shown) for connection of two or more power storage devices 10 of the present embodiment.

The base portion 41 is bonded to the back surface side of the end portion 12R of the sealing member 12 in the long-side direction (the direction X) via the insulating member 3. Further, the base adjoining portion 42 is adjacently continuous to the base portion 41 and in contact with the insulating member 3. A lead upper end portion 43a of the lead portion 43 is bent from the base adjoining portion 42 in a case inward direction (i.e., downward in the direction Z), and a lead lower end portion 43b is bonded by welding to the collected metal foil 21K, 22K of the active-material uncoated part 211, 221 of the electrode body 2. During welding of the electrode body 2 and the lead lower end portion 43b, the lead lower end portion 43b is apt to be subjected to an external force, and thus caused to slide on the metal foil 21K, 22K in the process of being collected together and displaced in the long-side direction of the sealing member 12, i.e., the direction X. This external force may be propagated to the sealing member 12, causing the central part of the sealing member 12 to be displaced in the front-back direction (the direction Z).

The sealing member 12 has a front surface 121 including two accuracy requiring surfaces 12S (12S1, 12S2) that require a required surface position accuracy. Herein, the accuracy requiring surfaces 12S (12S1, 12S2) are sensor contact surfaces 5S formed to be contactable with a temperature sensor 5 for monitoring the temperature of the power storage device 10, but they are not necessarily limited to the sensor contact surfaces 5S. As the temperature sensor 5, for example, a thermistor, a thermocouple, and so on, may be used. The temperature sensor 5, which is retained in a holder case 51 fixed to a mounting bracket 53, is biased into contact with the sensor contact surface 5S by a spring 52 or the like. The surface position accuracy of the sensor contact surface 5S is required to satisfy a required reference value KJ in order to ensure the measurement accuracy of the temperature sensor 5 in consideration of various fabrication errors.

For constituting a battery pack by connecting two or more power storage devices 10 in series, generally, the power storage devices 10 are oriented so that the long side surfaces 11A of the case bodies 11 adjacently arranged face each other while the long side surfaces 11B of the case bodies 11 adjacently arranged face each other, so that the external connection parts 45A for positive electrode and the external connection parts 45B for negative electrode are alternately aligned in the same direction. Accordingly, the sensor contact surface 5S may be formed in the accuracy requiring surface 12S (12S1) close to the positive external connection part 45A (as seen in FIG. 2) or formed in the accuracy requiring surface 12S (12S2) close to the negative external connection part 45B. Thus, the surface position accuracy of both the accuracy requiring surfaces 12S (12S1, 12S2) is required to satisfy a required reference value KJ.

### Method for Producing the Power Storage Device

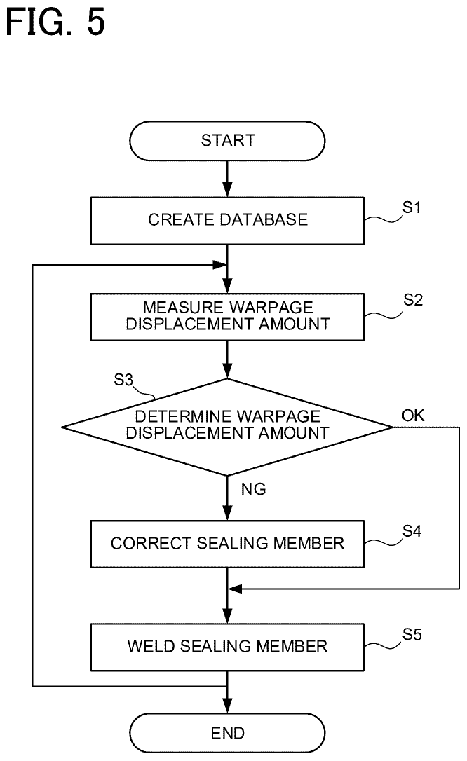

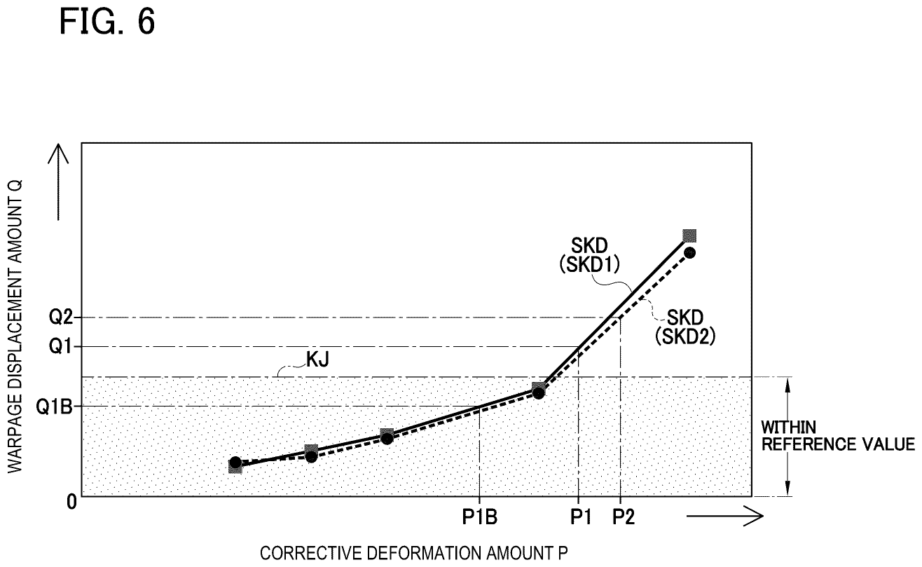

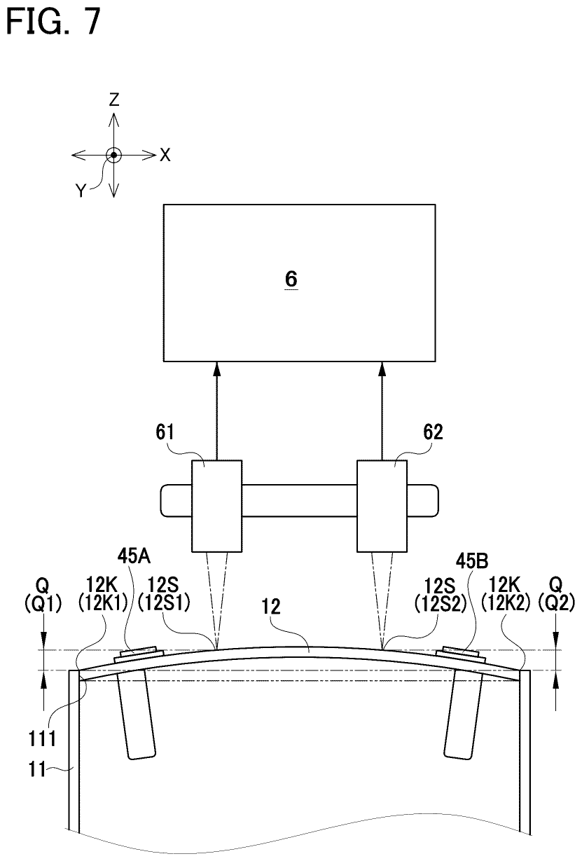

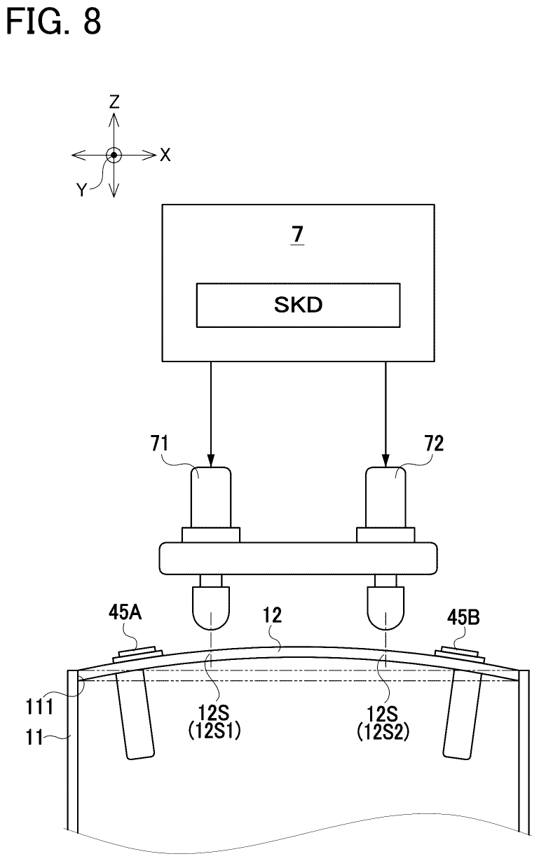

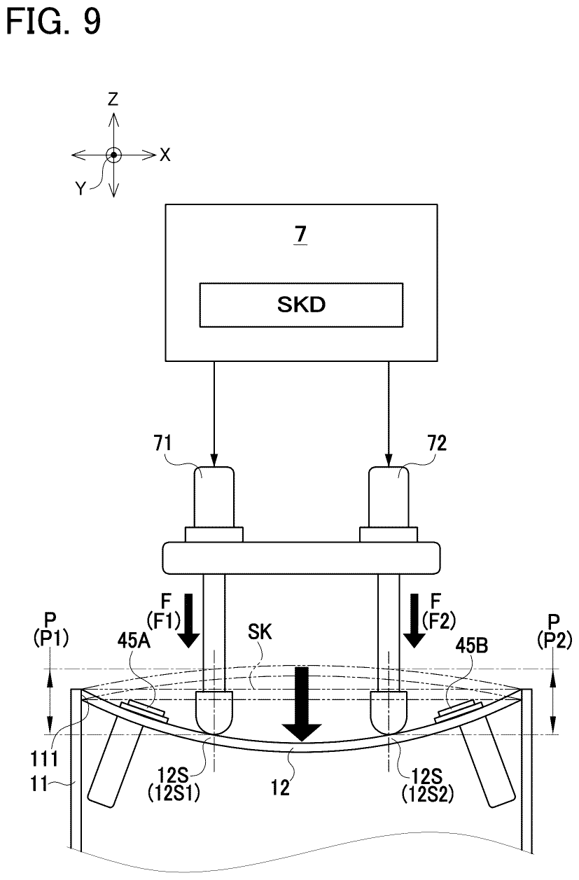

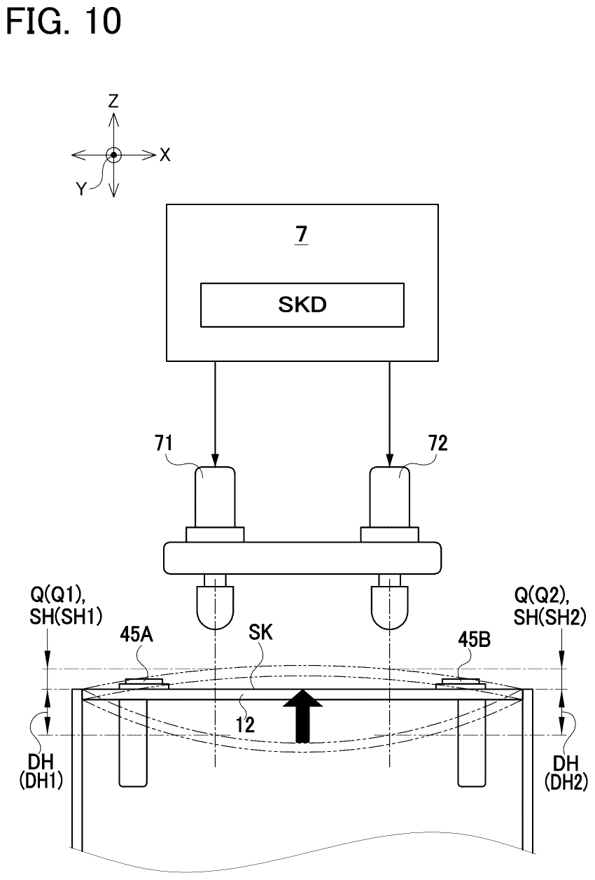

Next, the details of a method for manufacturing the power storage device in the present embodiment will be described below, referring to accompanied drawings. FIG. 5 is a flowchart showing the method for manufacturing the power storage device shown in FIG. 1. FIG. 6 shows one example of correlation graph data, which is accumulated in a database creating step in the flowchart shown in FIG. 5. FIG. 7 is a schematic cross-sectional view showing a method for measuring a warpage displacement amount of an accuracy requiring surface in the database creating step and a surface displacement measuring step in the flowchart in FIG. 5. FIG. 8 is a schematic cross-sectional view of a correcting device for correcting the warpage displacement amount of the accuracy requiring surface in a correcting step in the flowchart in FIG. 5. FIG. 9 is a schematic cross-sectional view of the correcting device shown in FIG. 8, in which a load is applied to a sealing member so that the accuracy requiring surface is deformed with a corrective deformation amount. FIG. 10 is a schematic cross-sectional view of the correcting device shown in FIG. 8, in which the load applied to deform the accuracy requiring surface with a corrective deformation amount is removed.

The power storage device manufacturing method in the present embodiment is a method for manufacturing the power storage device 10, including a correcting step S4 of correcting the sealing member 12 that sealingly closes the opening portion 111 of the case 1, in which the electrode body 2 is housed, prior to a sealing member welding step S5 of welding the sealing member 12 to the opening portion 111, as shown in FIG. 1 to FIG. 10. The sealing member 12 includes, in its front surface 121, the accuracy requiring surface 12S that requires a required surface position accuracy. The power storage device manufacturing method in the present embodiment includes a database creating step S1, a surface displacement measuring step S2, a displacement amount determining step S3, the correcting step S4, and the sealing member welding step S5. The sealing member welding step S5 is a step of welding the outer periphery of the sealing member 12, which is determined that the warpage displacement amount Q of the accuracy requiring surface 12S satisfies the reference value KJ in the displacement amount determining step S3 or which is corrected so that the warpage displacement amount Q of the accuracy requiring surface 12S is within the reference value KJ in the correcting step S4, to the opening portion 111 by laser welding or the like. In FIG. 7 to FIG. 10, the electrode body 2 is omitted, but is connected to the sealing member 12 via the current collector terminals 4 as shown in FIG. 2.

Herein, the accuracy requiring surface 12S will be described using the sensor contact surface 5S as an example, which is formed to be contactable with the temperature sensor 5 for monitoring the temperature of the power storage device 10 as described above. As shown in FIG. 1, FIG. 2, FIG. 6, and FIG. 7, the sensor contact surface 5S is a flat square or rectangle surface and formed as each of an accuracy requiring surface 12S (12S1) located close to the positive external connection part 45A and an accuracy requiring surface 12S (12S2) located close to the negative external connection part 45B. Both the accuracy requiring surfaces 12S (12S1, 12S2) are required to satisfy the required reference value KJ.

The reference value KJ indicates an allowable value or range of a warpage displacement amount Q of the surface position of the accuracy requiring surface 12S (12S1, 12S2) that is displaced in the front-back direction (the direction Z) of the sealing member 12 relative to the support point 12K of the sealing member 12. This reference value KJ is about ±0.2 to 0.3 mm (i.e., within a range of about plus or minus 0.2 to 0.3 mm), for example. The displacement of the sealing member 12 toward a front surface side in the front-back direction (i.e., upward in the direction Z in FIGS. 7-10) is indicated by a plus sign (+), and the displacement of the sealing member 12 toward a back surface side in the front-back direction (i.e., downward in the direction Z in FIGS. 7-10) is indicated by a minus sign (−). The correlation graph data SKD in FIG. 6 is one example where the surface position of the accuracy requiring surface 12S (12S1, 12S2) is displaced toward the front surface side in the front-back direction of the sealing member 12 (i.e., upward in the direction Z). Since the accuracy requiring surface 12S is the sensor contact surface 5S formed to be contactable with the temperature sensor 5 for monitoring the temperature of the power storage device 10, the measurement accuracy of the temperature sensor 5 can be enhanced and the temperature of the power storage device 10 can be avoided from excessively rising. This can further enhance the safety and the reliability of the power storage device 10.

The database creating step S1 is a step of accumulating in advance the correlation graph data SKD between the warpage displacement amount Q of the accuracy requiring surface 12S (12S1, 12S2) in the front-back direction (the direction Z) and the corrective deformation amount P by which the accuracy requiring surface 12S (12S1, 12S2) displaced by the warpage displacement amount is subjected to deformation for correction (corrective deformation) toward an opposite side in the front-back direction (the direction Z), i.e., upward or downward in the direction Z (which will be also referred to as an opposite front/back direction), opposite to a displacement direction of the accuracy requiring surface 12S (12S1, 12S2) relative to the support point 12K (12K1, 12K2), until the accuracy requiring surface 12S (12S1, 12S2) reaches a position from which the accuracy requiring surface 12S (12S1, 12S2) can be restored by its own elastic force to a normal position SK at which the warpage displacement amount Q is zero.

The correlation graph data SKD is created by the following steps, for example. The sealing member 12 bonded with the electrode body 2 via the current collector terminals 4 is inserted first in the opening portion 111 of the case body 11. Subsequently, as shown in FIG. 7, the surface position of each of the accuracy requiring surfaces 12S (12S1, 12S2) of the sealing member 12 in the front-back direction (the direction Z) of the sealing member 12 is measured. A device for measuring the surface position may be for example a non-contacting measuring device 6 having laser distance measuring devices 61, 62. Herein, each of the laser distance measuring devices 61, 62 emits a laser beam onto the center of the accuracy requiring surface 12S (12S1, 12S2) to measure its surface position. The measuring device 6 calculates, as a warpage displacement amount Q in the front-back direction (the direction Z), a difference between the surface position of each accuracy requiring surface 12S (12S1, 12S2) measured by the laser distance measuring devices 61, 62 and the surface position of the support point 12K serving as a reference. Then, the surface positions of the accuracy requiring surfaces 12S (12S1, 12S2) of the sealing members 12, which are different in warpage displacement amount Q, are measured, and various warpage displacement amounts Q are transmitted to the database of the correcting device 7 shown in FIG. 8.

As shown in FIG. 9, subsequently, an operating part or parts 71, 72 of the correcting device 7 are activated to perform corrective deformation of the accuracy requiring surface(s) 12S (12S1, 12S2) by applying a load F in the opposite front/back direction, which is opposite to the displacement direction of the accuracy requiring surface 12S relative to the support point 12K (12K1, 12K2), until the position from which the accuracy requiring surface(s) 12S (12S1, 12S2) having been displaced by the warpage displacement amount Q can be restored by its own elastic force to the normal position SK at which the warpage displacement amount Q is zero. Then, as shown in FIG. 10, the operating part or parts 71, 72 are returned to their original positions to remove the load F. The operating parts 71, 72 of the correcting device 7 may be configured to be driven by encoder-equipped servo-motors or the like to accurately control moving amounts, or distances, of the operating parts 71, 72. Further, the operating parts 71, 72 of the correcting device 7 may be operated to repeat, two or more times, the corrective deformation of the corresponding accuracy requiring surface(s) 12S (12S1, 12S2) and the removal of the load to gradually increase the deformation amount until reaching the predetermined corrective deformation amount P.

The correcting device 7 creates the correlation graph data SKD (SKD1, SKD2) based on the warpage displacement amount Q transmitted from the measuring device 6 and the corrective deformation amount P by which the accuracy requiring surface(s) 12S (12S1, 12S2) has been subjected to corrective deformation by this load F, as shown in FIG. 6, and stores it in the database. The operating parts 71, 72 of the correcting device 7 may also be configured such that, even when the accuracy requiring surfaces 12S (12S1, 12S2) have been displaced toward the back surface side of the sealing member 12, the operating parts 71, 72 can be switched to a structure (for example, an adsorption structure or a pull-up structure) that can apply the load F in the opposite front/back direction (the direction Z) opposite to the displacement direction of the accuracy requiring surfaces 12S.

Herein, the correlation graph data SKD1 is a correlation curve representing the correlative relationship between the warpage displacement amount Q and the corrective deformation amount P of the accuracy requiring surface 12S (12S1) located close to the positive external connection part 45A. Further, the correlation graph data SKD2 is a correlation curve representing the correlative relationship between the warpage displacement amount Q and the corrective deformation amount P of the accuracy requiring surface 12S (12S2) located close to the negative external connection part 45B. The correlation graph data SKD1, SDK2 shown in FIG. 6 are plotted as line graphs, but instead may be plotted as curve graphs by increasing measurement data.

As shown in FIG. 6, in the region where the warpage displacement amount Q is within the reference value KJ, the correlation graph data SKD1 and the correlation graph data SKD1 are less different in warpage displacement amount Q relative to the same corrective deformation amount P. In contrast, in the region where the warpage displacement amount Q is not within the reference value KJ, the data SKD1 and SKD2 are increasingly different in the warpage displacement amount Q relative to the same corrective deformation amount P. This is presumably because the liquid inlet 123 and the safety valve 124, which are factors that reduce the strength of the sealing member 12, are located on the accuracy requiring surface 12S (12S1) side closer to the positive external connection part 45A. However, even when the warpage displacement amount Q of the sealing member 12 varies for each power storage device 10 to be manufactured and also differs between the positive side and the negative side in each power storage device 10 to be manufactured, it is possible to easily and correctly find the corrective deformation amount P for correcting the warpage displacement amount Q based on the correlation graph data SKD (SKD1, SKD2) accumulated in the database creating step S1. Since the correlation graph data SKD (SKD1, SKD2) accumulated in the database creating step S1 vary depending on the size, type, and other conditions of the power storage devices 10, the correlation graph data SKD (SKD1, SKD2) may be created in advance for each power storage device 10 and accumulated in the database.

As shown in FIG. 5, in the surface displacement measuring step S2, the sealing member 12 is inserted in the opening portion 111 and then the warpage displacement amount Q (Q1, Q2) of the accuracy requiring surface 12S (12S1, 12S2), which is the surface displacement, is measured. In the displacement amount determining step S3, thereafter, it is determined whether or not the warpage displacement amount Q (Q1, Q2) of the accuracy requiring surface 12S (12S1, 12S2) measured in the surface displacement measuring step S2 satisfies the required reference value KJ. The method for measuring the warpage displacement amount Q (Q1, Q2) of the accuracy requiring surface 12S in the surface displacement measuring step S2 is performed using the measuring device 6 shown in FIG. 7, as described above.

Therefore, at the stage before the sealing member 12 is welded to the opening portion 111, the surface position of the accuracy requiring surface 12S (12S1, 12S2) can be measured and determined as good or not. Consequently, it is not necessary to take account of various causes of warpage of the sealing member 12. It is also not necessary to measure the surface position of areas other than the accuracy requiring surface 12S and determine whether it is good or not. This can simplify the surface displacement measuring step S2 and the displacement amount determining step S3, and contribute to productivity improvement.

In the correcting step S4, as shown in FIGS. 6, 9, and 10, when it is determined, in the displacement amount determining step S3, that the warpage displacement amount Q (Q1, Q2) does not satisfy the required reference value KJ (S3: NG (no good)), the load F (F1, F2) is applied to the accuracy requiring surface 12S (12S1, 12S2) until a position corresponding to the corrective deformation amount P (P1, P2) determined when the warpage displacement amount Q (Q1, Q2) measured in the surface displacement measuring step S2 coincides with the warpage displacement amount Q (Q1, Q2) in the correlation graph data SKD (SKD1, SKD2). Then, the load F (F1, F2) is removed. On the other hand, in the displacement amount determining step S3, when it is determined that the warpage displacement amount Q (Q1, Q2) satisfies the required reference value KJ (S3: OK), the process proceeds to the sealing member welding step S5.

This can correct the warpage displacement amount Q (Q1, Q2) by targeting only the accuracy requiring surface 12S (12S1, 12S2) whose warpage displacement amount Q (Q1, Q2) does not satisfy the required reference value KJ. The corrective deformation amount P (P1, P2) is a deformation amount allowing the accuracy requiring surface 12S (12S1, 12S2) displaced by the warpage displacement amount Q (Q1, Q2) to be restored by its own elastic force to a normal position SK at which the warpage displacement amount Q is zero. Thus, a difference obtained by subtracting an elastic deformation amount DH (DH1, DH2) from the corrective deformation amount P (P1, P2) is a plastic deformation amount SH (SH1, SH2) after correcting, which coincides with the warpage displacement amount Q (Q1, Q2) before correcting.

The power storage device manufacturing method according to the present embodiment is the method for manufacturing the power storage device 10, in which the correcting step S4 of correcting the sealing member 12 is performed prior to the sealing member welding step S5 where the sealing member 12 sealingly closing the opening portion 111 of the case 1 containing the electrode body 2 is welded to the opening portion 111. The front surface 121 of the sealing member 12 includes the accuracy requiring surface 12S that needs a required surface position accuracy. This method includes the database creating step S1 of accumulating in advance the correlation graph data SKD between the warpage displacement amount Q of the accuracy requiring surface 12S in the front-back direction (the direction Z) relative to the support point 12K (12K1, 12K2) of the sealing member 12 inserted in the opening portion 111 and the corrective deformation amount P by which the accuracy requiring surface 12S displaced by the warpage displacement amount Q has been subjected to corrective deformation in the opposite front/back direction (the direction Z) to the displacement direction relative to the support point 12K of the accuracy requiring surface 12S until the position from which the accuracy requiring surface 12S can be restored by its own elastic force to the normal position SK at which the warpage displacement amount Q is zero, the surface displacement measuring step S2 of measuring the warpage displacement amount Q of the accuracy requiring surface 12S of the sealing member 12 after the sealing member 12 is inserted in the opening portion 111, and the displacement amount determining step S3 of determining whether or not the warpage displacement amount Q of the accuracy requiring surface 12S measured in the surface displacement measuring step S2 satisfies the required reference value KJ. When it is determined, in the displacement amount determining step S3, that the warpage displacement amount Q does not satisfy the required reference value KJ, the correcting step S4 is performed by applying the load F to the accuracy requiring surface 12S until the position corresponding to the corrective deformation amount P determined when the warpage displacement amount Q measured in the surface displacement measuring step S2 coincides with the warpage displacement amount Q in the correlation graph data SKD, and then removing the load F.

According to the method for manufacturing the power storage device 10 in the present embodiment, therefore, even when the warpage displacement amount Q of the sealing member 12 is different for each power storage device 10 to be manufactured and the warpage displacement amount Q is asymmetric between right and left sides of the sealing member 12, it is possible to manufacture a reliable power storage device by changing the corrective deformation amount P according to the warpage displacement amount Q and correcting the accuracy requiring surface 12S of the sealing member 12 so that the warpage displacement amount Q is within the reference value KJ.

In the power storage device manufacturing method in the present embodiment, moreover, the front surface 121 of the sealing member 12 includes two or more accuracy requiring surfaces 12S (12S1, 12S2). In the surface displacement measuring step S2, the warpage displacement amount Q (Q1, Q2) of each of the accuracy requiring surfaces 12S (12S1, 12S2) is measured. When it is determined, in the displacement amount determining step S3, that the warpage displacement amount Q (Q1, Q2) of at least one of the accuracy requiring surfaces 12S (12S1, 12S2) does not satisfy the required reference value KJ, the correcting step S4 is performed by applying the load F (F1, F2) to each of the accuracy requiring surfaces 12S (12S1, 12S2) until the position corresponding to an average value ((P1B+P2)×½) of the corrective deformation amounts P (P1B, P2), which are determined when each of the warpage displacement amounts Q (Q1B, Q2) measured in the surface displacement measuring step S2 coincides with the warpage displacement amount Q (A1B, Q2) in the correlation graph data SKD (SKD1, SKD2) shown in FIG. 6, and then removing the load F (F1, F2).

In this case, even when the sealing member 12 includes two or more accuracy requiring surfaces 12S (12S1, 12S2), the load F (F1, F2) is applied until the position corresponding to an average value ((P1B+P2)×½) of the corrective deformation amounts P (P1B, P2) determined when each warpage displacement amount Q (Q1B, Q2) measured in the surface displacement measuring step S2 coincides with the warpage displacement amount Q (A1B, Q2) in the correlation graph data SKD (SKD1, SKD2), and then the load F (F1, F2) is removed. This method does not need to deform the two or more accuracy requiring surfaces 12S (12S1, 12S2) separately with respective corrective deformation amounts P (P1B, P2), which can simplify the structure of the correcting device 7 to apply the load F (F1, F2) to each accuracy requiring surface 12S (12S1, 12S2). Consequently, the accuracy requiring surfaces 12S of the sealing member 12 can be corrected to within the reference value KJ at a lower cost and in a shorter time.

### Modified Example

The foregoing embodiments are mere examples and give no limitation to the present disclosure. The disclosure may be embodied in other specific forms without departing from the essential characteristics thereof.

### REFERENCE SIGNS LIST

1 Case
2 Electrode body
5 Temperature sensor
5S Sensor contact surface
10 Power storage device
12 Sealing member
12K, 12K1, 12K2 Support point
12S, 12S1, 12S2 Accuracy requiring surface
111 Opening portion
121 Front surface
F, F1, F2 Load
KJ Reference value
P, P1, P1B, P2 Corrective deformation amount
Q, Q1, Q1B, Q2 Warpage displacement amount
S1 Database creating step
S2 Surface displacement measuring step
S3 Displacement amount determining step
S4 Correcting step
S5 Sealing member welding step
SK Normal position
SKD, SKD1, SKD2 Correlation graph data

What is claimed is:

1. A method for manufacturing a power storage device, the method including correcting a sealing member that sealingly closes an opening portion of a case containing an electrode body, prior to welding the sealing member to the opening portion of the case,
wherein the sealing member has a front surface including an accuracy requiring surface that requires a required surface position accuracy,
the method comprises:
creating database by accumulating in advance correlation graph data between a warpage displacement amount of the accuracy requiring surface displaced in a front-back direction relative to a support point of the sealing member inserted in the opening portion of the case and a corrective deformation amount by which the accuracy requiring surface displaced by the warpage displacement amount is subjected to corrective deformation toward an opposite side in the front-back direction to a displacement direction of the accuracy requiring surface relative to the support point until the accuracy requiring surface reaches a position from which the accuracy requiring surface can be restored by its own elastic force to a normal position at which the warpage displacement amount is zero;
measuring a warpage displacement amount of the accuracy requiring surface after the sealing member is inserted in the opening portion;
determining whether or not the warpage displacement amount of the accuracy requiring surface measured in measuring the warpage displacement amount satisfies a required reference value, and
when it is determined, in determining the warpage displacement amount, that the warpage displacement amount does not satisfy the required reference value, correcting the sealing member is performed by applying a load to the accuracy requiring surface until a position corresponding to the corrective deformation amount determined when the warpage displacement amount measured in measuring the warpage displacement amount coincides with the warpage displacement amount in the correlation graph data, and then removing the load.

2. The method for manufacturing a power storage device, according to claim 1, wherein the accuracy requiring surface is a sensor contact surface formed to be contactable with a temperature sensor for monitoring a temperature of the power storage device.

3. The method for manufacturing a power storage device, according to claim 1, wherein the accuracy requiring surface in the front surface of the sealing member includes a plurality of accuracy requiring surfaces,
measuring the warpage displacement amount includes measuring the warpage displacement amount of each of the accuracy requiring surfaces,
when it is determined, in determining the warpage displacement amount, that the warpage displacement amount of at least one of the accuracy requiring surfaces does not satisfy the required reference value, correcting the sealing member is performed by applying the load to each of the accuracy requiring surfaces until the position corresponding to an average value of the corrective deformation amounts each determined when each of the warpage displacement amounts measured in measuring the warpage displacement amount coincides with the warpage displacement amount in the correlation graph data, and then removing the load.

4. The method for manufacturing a power storage device, according to claim 2, wherein the accuracy requiring surface in the front surface of the sealing member includes a plurality of accuracy requiring surfaces,
measuring the warpage displacement amount includes measuring the warpage displacement amount of each of the accuracy requiring surfaces,
when it is determined, in determining the warpage displacement amount, that the warpage displacement amount of at least one of the accuracy requiring surfaces does not satisfy the required reference value, correcting the sealing member is performed by applying the load to each of the accuracy requiring surfaces until the position corresponding to an average value of the corrective deformation amounts each determined when each of the warpage displacement amounts measured in measuring the warpage displacement amount coincides with the warpage displacement amount in the correlation graph data, and then removing the load.
